(19) United States
(12) Patent Application Publication
(10) Pub. No.: US 2026/0042054 A1
(43) Pub. Date: Feb. 12, 2026

(54) EXHAUST GAS TREATMENT APPARATUS

(71) Applicant: ECO-Energen, Cheonan-si (KR)

(72) Inventor: Jong Pil YOON, Cheonan-si (KR)

(21) Appl. No.: 19/295,512

(22) Filed: Aug. 8, 2025

(30) Foreign Application Priority Data
Aug. 12, 2024 (KR) 10-2024-0107350

(51) Int. Cl. B01D 53/32

(52) U.S. Cl. CPC B01D 53/32; B01D 2257/40; B01D 2259/818

(57) ABSTRACT

An exhaust gas treatment apparatus for decomposing or treating exhaust gases such as PFCs is disclosed. Exhaust gas flowing from a vacuum chamber is introduced into a first exhaust gas decomposition unit and a second exhaust gas decomposition unit. Nitrogen gas supplied within the treatment space of the inner wall of the exhaust gas decomposition unit rotates along the inner wall. Nitrogen plasma concentrated at the center of the treatment space effectively decomposes the exhaust gas, preventing powder or radicals within the exhaust gas from being adhered onto the inner wall.

### TECHNICAL FIELD

The present inventive concept relates to an exhaust gas treatment apparatus, and more specifically, to an apparatus for decomposing and treating exhaust gas through a plasma flame.

### BACKGROUND ART

Exhaust gas is generated by various causes. Beyond being produced by fuel combustion during vehicle operation, exhaust gas is generated in a wide variety of industrial fields. Particularly, semiconductor or display manufacturing processes involve diverse manufacturing steps and utilize various process equipment. Each process equipment requires its own specific process gas, and this process gas is discharged as exhaust gas after the necessary process is completed.

Specifically, process gases are supplied to the process chamber and react with the underlayer through processes like deposition to form a specific layer. After the desired layer is formed, unreacted gases and reaction byproducts are discharged outside the process chamber. Gases discharged outside the process chamber that are not recycled are commonly referred to as exhaust gases.

Conventional exhaust gas contains toxic components due to various causes. As this gas is discharged outside the process chamber via a vacuum pump, it should be changed into harmless gas in subsequent stages. Prior to changing, the exhaust gas should be decomposed. Notably, exhaust gas is not a single component but consists of various gases or powders. Consequently, depending on temperature and pressure conditions, these components react with each other, forming powders on pipe surfaces or forming particles that obstruct fluid flow in the exhaust gas discharge pipes or interferes with vacuum pump operation.

Furthermore, even when the exhaust gas is entered into the treatment apparatus by using the vacuum pump, unwanted side reactions can interfere with the operation of the exhaust gas treatment apparatus. The exhaust gas treatment apparatus, commonly referred to as a scrubber, has various forms and treatment mechanism. Methods for treating exhaust gas include direct combustion, plasma decomposition, and catalytic decomposition.

Direct combustion involves burning the exhaust gas directly at temperatures over 1,400° C., using combustible gas for combustion. However, this method has the disadvantage of requiring high temperatures, which makes maintenance of the exhaust gas treatment apparatus difficult.

Furthermore, while the catalytic decomposition method offers advantages in terms of processing temperature, it suffers from the disadvantage that the catalysts used are prone to physical or chemical degradation and cannot maintain their active state during long periods.

The plasma decomposition method involves passing exhaust gas through a plasma zone, where it undergoes decomposition. However, since plasma is a high-temperature activated ionized gas, it generates unwanted radicals and causes deposition problems on the inner walls of the exhaust gas treatment apparatus. Particularly, the exhaust gas contains perfluorinated compounds (PFCs) and includes powder in the form of metal compounds, in addition to gaseous components. When powder is present in the exhaust gas, its surface becomes ionized by the plasma, leading to adhesion onto the inner walls of the exhaust gas treatment apparatus. Furthermore, the exhaust gas introduced into the plasma generates numerous unidentified radicals, which also adhere onto the inner walls of the exhaust gas treatment apparatus, reducing its efficiency of the exhaust gas treatment apparatus.

Therefore, a technology is sought to prevent radicals or ionized powders from adhering onto the inner walls of the exhaust gas treatment apparatus and reducing its treatment efficiency of an apparatus that uses plasma to treat exhaust gas.

### DISCLOSURE

### Technical Problem

The present inventive concept is to provide an exhaust gas treatment apparatus positioned downstream of a vacuum pump, thereby improving the treatment efficiency of exhaust gas.

### Technical Solution

One aspect of the present inventive concept provides an exhaust gas treatment apparatus comprising an exhaust gas inlet into which exhaust gas is introduced, a plasma supply unit generating nitrogen plasma via arc discharge; a first exhaust gas decomposition unit where the nitrogen plasma is supplied, and having a first central region and a first peripheral region outside the first central region in a first inner wall, wherein the exhaust gas is firstly treated by the nitrogen plasma in the first central region and a first nitrogen gas rotates in the first peripheral region; a second exhaust gas decomposition unit connected to the first exhaust gas decomposition unit, having a second central region and a second peripheral region outside the second central region in a second inner wall, wherein the exhaust gas is secondary treated by the nitrogen plasma in the second central region and newly supplied second nitrogen gas rotates in the second peripheral region to confine the nitrogen plasma; and a sealing unit that connecting the first exhaust gas decomposition unit and the second exhaust gas decomposition unit, and inducing rotational movement by the inflow of the second nitrogen gas.

Another aspect of the present inventive concept provides an exhaust gas treatment apparatus comprising an exhaust gas inlet in which exhaust gas is introduced; a plasma supply unit for forming a nitrogen plasma to decompose the exhaust gas, into which a first nitrogen gas is introduced to induce rotational motion; a first exhaust gas decomposition unit connected to the plasma supply unit, into which the exhaust gas is introduced for decomposition, in which the nitrogen plasma is confined by the rotational motion of the first nitrogen gas and the exhaust gas is firstly decomposed by the nitrogen plasma; a second exhaust gas decomposition unit connected to the first exhaust gas decomposition unit, in which the exhaust gas is secondary decomposed and the nitrogen plasma is confined by the rotation of second nitrogen gas; and a sealing unit for connecting the first exhaust gas decomposition unit and the second exhaust gas decomposition unit, and for supplying the second nitrogen gas.

### Advantageous Effect

According to the present inventive concept, the treatment space within the exhaust gas decomposition unit is defined as a central region and a peripheral region. Nitrogen plasma is defined through the central region, and inert nitrogen gas is supplied to the peripheral region by rotating along the inner wall. The concentration of nitrogen plasma increases due to the nitrogen gas rotating along the inner wall, thereby improving the treatment efficiency of the exhaust gas. Furthermore, the phenomenon where powder or reactive radicals introduced into the plasma deposit on the inner wall of the exhaust gas decomposition unit, blocking the space of the inner wall or contaminating the treatment space, is prevented.

Furthermore, to compensate for the limited processing capacity of the first exhaust gas decomposition unit, a second exhaust gas decomposition unit is connected. Nitrogen gas flows within the processing space of the second exhaust gas treatment unit, rotating around the outer periphery in the same direction as the first exhaust gas treatment unit. This protects the inner wall of the second exhaust gas treatment unit from adhesion of powder and other materials.

### DESCRIPTION OF DRAWINGS

FIG. 1 is a front cross-sectional view illustrating exhaust gas treatment apparatus according to a preferred embodiment of the present inventive concept.

FIG. 2 is a cross-sectional view of the exhaust gas treatment apparatus of FIG. 1 as viewed from the right side according to a preferred embodiment of the present inventive concept.

FIG. 3 is an enlarged cross-sectional view of the area where the second nitrogen inlet of FIG. 1 is connected, according to a preferred embodiment of the present inventive concept.

FIG. 4 is an upper cross-sectional view cut along line AA′ of FIG. 3 according to a preferred embodiment of the present inventive concept.

FIG. 5 is cross-sectional view cut along line BB′ of FIG. 3 according to a preferred embodiment of the present inventive concept.

FIG. 6 is an enlarged cross-sectional view of the sealing unit of FIG. 1 according to a preferred embodiment of the present inventive concept.

FIG. 7 is cross-sectional view cut along line CC′ of FIG. 6 according to a preferred embodiment of the present inventive concept.

FIG. 8 is cross-sectional view along line DD′ of FIG. 6 according to a preferred embodiment of the present inventive concept.

FIG. 9 is a graph for verifying the N₂O treatment capacity according to Experimental Example 1 of the present inventive concept.

FIG. 10 is a cross-sectional image showing the case where the nitrogen gas supplied to the second nitrogen inlet and the third nitrogen inlet is cut off according to Experimental Example 2 of the present inventive concept.

FIG. 11 shows cross-sectional views of the exhaust gas treatment apparatus of Experimental Example 2 of the present inventive concept when nitrogen plasma is activated and nitrogen gas is supplied through the second nitrogen inlet and third nitrogen inlet.

### MODES OF THE INVENTIVE CONCEPT

The present inventive concept may be subject to various modifications and may take various forms. Specific embodiments are illustrated in the drawings and described in detail herein. However, this is not intended to limit the inventive concept to the specific forms disclosed, and it should be understood that the inventive concept encompasses all modifications, equivalents, and substitutes falling within the scope of the inventive concept's concept and technical field. Similar reference numerals are used for similar components throughout the drawings.

Unless otherwise defined, all terms used herein, including technical or scientific terms, have the same meaning as generally understood by one skilled in the art to which the inventive concept pertains. Terms defined in commonly used dictionaries shall be interpreted to have the meaning consistent with the context of the relevant technology and shall not be interpreted in an idealistic or overly formalistic sense unless explicitly defined in this application.

Hereinafter, with reference to the accompanying drawings, a preferred embodiment of the present inventive concept will be described in more detail.

### EMBODIMENT

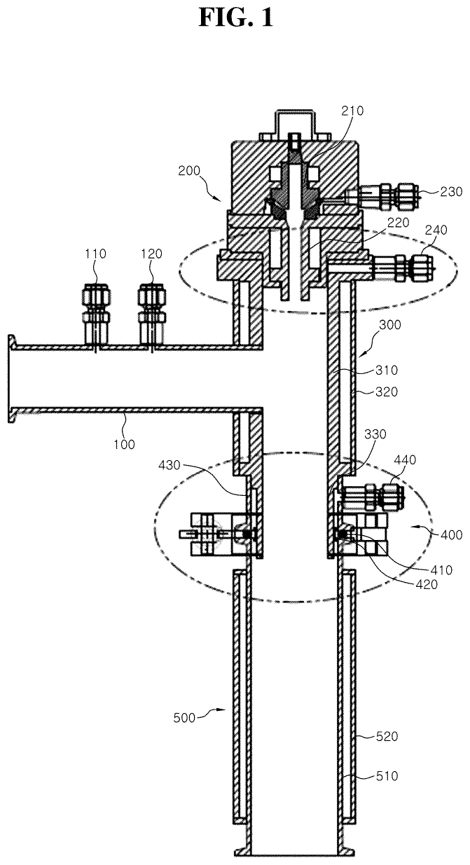

FIG. 1 is a front cross-sectional view illustrating exhaust gas treatment apparatus according to a preferred embodiment of the present inventive concept.

Referring to FIG. 1, the exhaust gas treatment apparatus comprises an exhaust gas inlet 100, a plasma supply unit 200, a first exhaust gas decomposition unit 300, a sealing unit 400, and a second exhaust gas decomposition unit 500.

The exhaust gas inlet 100 is connected to a vacuum pump, and PFCs or powders are introduced from the vacuum pump. The powders may be aggregates of metal compounds or organic materials.

The exhaust gas in the present inventive concept includes PFCs and powders. Additionally, various gases subject to decomposition correspond to the exhaust gas. A pressure sensor 110 and a temperature sensor 120 may be placed in the path through which the exhaust gas flows via the exhaust gas inlet 100. The pressure of the exhaust gas is detected via the pressure sensor 110, and the temperature of the detected exhaust gas via the temperature sensor 120 subsequently may be used as fundamental data for controlling plasma power during the exhaust gas decomposition operation using nitrogen plasma.

The plasma supply unit 200 generates nitrogen plasma, and the generated plasma flame is supplied to the first exhaust gas decomposition unit 300 and the second exhaust gas decomposition unit 500. The plasma supply unit 200 comprises a cathode 210, an anode 220, a first nitrogen inlet 230, and a second nitrogen inlet 240.

Nitrogen gas that is the source gas, is introduced through the first nitrogen inlet 230. Nitrogen gas introduced through the first nitrogen inlet 230 is formed into high-temperature nitrogen plasma by the arc discharge between the cathode 210 and the anode 220, and is discharged through the discharge port of the anode 220.

Additionally, a second nitrogen inlet 240 is provided below the first nitrogen inlet 230. Nitrogen gas supplied through the second nitrogen inlet 240 has its pressure increased through a micro-channel and performs a fluid motion rotating around the inner wall of the first exhaust gas decomposition unit 300. Moreover, the nitrogen gas introduced through the second nitrogen inlet 230 cools the high-temperature nitrogen plasma in the path flowing into the first exhaust gas decomposition unit 300 and prevents powders from depositing on the inner wall of the first exhaust gas decomposition unit 300.

The plasma supply unit 200 is connected to the first exhaust gas decomposition unit 300. The first exhaust gas decomposition unit 300 is connected to an exhaust gas inlet 100, allowing exhaust gas to flow into the first exhaust gas decomposition unit 300.

The first exhaust gas decomposition unit 300 has a first inner wall 310, a first outer wall 320, and a tapered inner wall 330. Cooling water is supplied to the space between the first inner wall 310 and the first outer wall 320. The cooling water flows while rotating within the gap space of the first exhaust gas decomposition unit 300, which has an approximately circular cross shape, and cools the first inner wall 310. The exhaust gas flowing into the first exhaust gas decomposition unit 300 undergoes first decomposition by the nitrogen plasma.

The temperature of the plasma within the first exhaust gas decomposition unit 300 is preferably set to 700° C. to 1,000° C. The temperature of the plasma flame generated in the plasma supply unit 200 is 1,500° C. or higher, and it is firstly cooled by the nitrogen gas introduced through the second nitrogen inlet 240 during the inflow process into the first exhaust gas decomposition unit 300.

If the plasma temperature within the first exhaust gas decomposition unit 300 exceeds 1,000° C., unexpected powder formation may occur due to radical side reactions caused by the plasma. This powder may deposit on the surface of the first inner wall 310, or secondary byproducts such as NOx or SOx may be formed.

In particular, the reaction space defined by the first inner wall 310 of the first exhaust gas decomposition unit 300 can be divided into at least two regions.

The central region, defined as having a predetermined radius from the center, contains the plasma flame and exhaust gas, where the decomposition of the exhaust gas occurs.

Additionally, in the peripheral region between the central region and the surface of the first inner wall 310, nitrogen gas introduced through the second nitrogen inlet 240 flows in a rotating manner along the surface of the first inner wall 310, thereby forming a barrier or curtain of nitrogen gas. Therefore, the phenomenon of plasma, exhaust gas, powder, or reactive radicals being adhered or deposited onto the metallic first inner wall 310 is prevented.

In particular, since the nitrogen gas and the nitrogen plasma have the same nitrogen gas source, the nitrogen gas serves as an excellent means to suppress side reactions between the plasma and the nitrogen gas. That is, when using a gas of the same type with the plasma source gas as the barrier gas protecting the exhaust gas decomposition unit, it effectively confines the plasma within a specific area.

A second exhaust gas decomposition unit 500 is connected to the bottom of the first exhaust gas decomposition unit 300. The second exhaust gas decomposition unit 500 has a second inner wall 510 and a second outer wall 520. Cooling water is filled and flows within the gap space between the second inner wall 510 and the second outer wall 520.

The inner diameter of the second inner wall 510 is preferably set larger than the inner diameter of the first inner wall 310. A portion of the upper end of the second inner wall 510 is connected to the first inner wall 310 in a configuration where it externally wraps around a portion of the tapered inner wall 330.

A portion or all of the plasma flame supplied to the first exhaust gas decomposition unit 300 is supplied to the reaction space of the second exhaust gas decomposition unit 500. Specifically, since the inner diameter of the second inner wall 510 is larger than inner diameter of the inner diameter of the first inner wall 310, the second exhaust gas decomposition unit 500 maintains a lower pressure than the first exhaust gas decomposition unit 300, allowing un-decomposed exhaust gas or particulate matter from the first exhaust gas decomposition unit 300 to easily diffuse and undergo second decomposition. The exhaust gas temperature at the second exhaust gas decomposition unit 500 is preferably between 300° C. and 500° C.

That is, the temperature of the second exhaust gas decomposition unit 500 is set lower than that of the first exhaust gas decomposition unit 300, performing the two-stage decomposition operation of the present inventive concept. The reason for adopting a two-stage decomposition strategy for exhaust gas decomposition is as follows.

First, PFCs and other substances in the exhaust gas have diverse compositions, and their decomposition temperatures vary owing to composition. For example, representative PFCs include NF3, CF4, C2F6, and SF6. When using direct combustion, CF4 has the highest decomposition temperature, while NF3 has the lowest decomposition temperature. The difference between the highest and lowest decomposition temperatures is approximately 400° C. If a strategy to decompose all PFCs in a single space is employed, the problem arises that various PFCs cannot be effectively decomposed. Therefore, in the present inventive concept, while utilizing plasma, the reaction space is separated into two parts. In the first exhaust gas decomposition unit 300, most PFCs are decomposed through decomposition at a high decomposition temperature. However, some PFCs may remain undecomposed, and other byproducts may form due to the high nitrogen plasma density. These are decomposed in the second exhaust gas decomposition unit 500.

Second, suppression of side reactions is necessary. If exhaust gas remains within the first exhaust gas decomposition unit 300, where PFCs and others decompose at relatively high temperatures, for a certain period, side reactions easily occur. Therefore, to prevent this, the second exhaust gas decomposition unit 500 has a large internal diameter, rapidly dispersing the gases of the first exhaust gas decomposition unit 300 within the second exhaust gas decomposition unit 500. Furthermore, the relatively lower temperature allows for the easy decomposition of PFCs with low decomposition temperatures, such as NF3, which remain undecomposed in the first exhaust gas decomposition unit 300.

Furthermore, a sealing unit 400 is positioned between the first exhaust gas decomposition unit 300 and the second exhaust gas decomposition unit 500.

The sealing unit 400 connects the first exhaust gas decomposition unit 300 and the second exhaust gas decomposition unit 500, and includes an O-ring 410, a centering ring 420, a sealing housing 430, and a third nitrogen inlet 440 formed on the second inner wall 510. The second inner wall 510 has a larger inner diameter than that of the first inner wall 310, and the outer diameter of the second inner wall 510 is larger than the outer diameter of the tapered inner wall 330. Therefore, the second inner wall 510 is provided in a form that accommodates the tapered inner wall 330.

An O-ring 410 is positioned on the upper surface of the second inner wall 510, and a centering ring 420 is connected to the O-ring 410 to prevent its dislodgement. A sealing housing 430 is positioned above the O-ring 410.

The inner diameter of the sealing housing 430 is larger than the outer diameter of the tapered inner wall 330 and is preferably set equal to the outer diameter of the first inner wall 310. Furthermore, the sealing housing 430 is formed while enveloping the tapered inner wall 330, creating a gap space between the tapered inner wall 330.

A flow path is formed for nitrogen gas, so nitrogen gas flows into the third nitrogen inlet 440 through the gap space between the tapered inner wall 330 and the sealing housing 430. Through the formation of the flow path, the nitrogen gas flows in a rotating manner along the surface of the second inner wall 510 of the second exhaust gas decomposition unit 500.

Consequently, the processing space within the second exhaust gas decomposition unit 500 is divided into a central region and a peripheral region. The peripheral region forms a kind of non-reactive, inert gas barrier as the nitrogen gas entering through the third nitrogen inlet 440 rotates along the surface of the second inner wall 510. Consequently, only within the central region of the second exhaust gas decomposition unit 500 are nitrogen plasma, exhaust gas, and decomposed gases defined, and contact with the second inner wall 510 is substantially prevented.

This allows the decomposition of exhaust gas by the nitrogen plasma to occur in two distinct spaces, prevents the deposition of radicals, powder, or charged particles on the inner wall of the reaction space, and maximizes the decomposition efficiency of the exhaust gas.

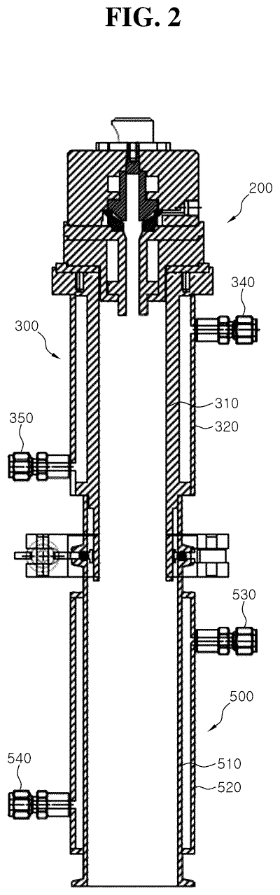

FIG. 2 is a cross-sectional view of the exhaust gas treatment apparatus of FIG. 1 as viewed from the right side according to a preferred embodiment of the present inventive concept.

Referring to FIG. 2, a first cooling water inlet 340 is connected to the first outer wall 310 in the upper region of the first exhaust gas decomposition unit 300, and a first cooling water outlet 350 is connected to the lower region. Furthermore, the first cooling water flows while rotating through the gap space between the first inner wall 310 and the first outer wall 320. Therefore, the first exhaust gas decomposition unit 300 can be uniformly cooled.

Specifically, the first cooling water inlet 340 is positioned close to the plasma supply unit 200. The first cooling water near the first cooling water inlet 340 has a lower temperature compared to the first cooling water near the first cooling water outlet 350. Therefore, the temperature of the nitrogen plasma can be rapidly lowered. Since the first cooling water at the first cooling water outlet 350 has a relatively high temperature, the temperature distribution within the first exhaust gas decomposition unit 300 can be uniformly distributed across both the upper and lower regions. This allows effective utilization of the space within the first exhaust gas decomposition unit 300, and the decomposition of exhaust gas proceeds effectively within the defined central region.

Furthermore, the second exhaust gas decomposition unit 500 has a second cooling water inlet 530 connected to its upper region and a second cooling water outlet 540 connected to its lower region. The second cooling water flows through the gap space between the second inner wall 510 and the second outer wall 520, rotating within the gap space while flowing downward. This cools the second exhaust gas decomposition unit 500 while simultaneously maintaining the uniformity of the temperature distribution within the second exhaust gas decomposition unit 500.

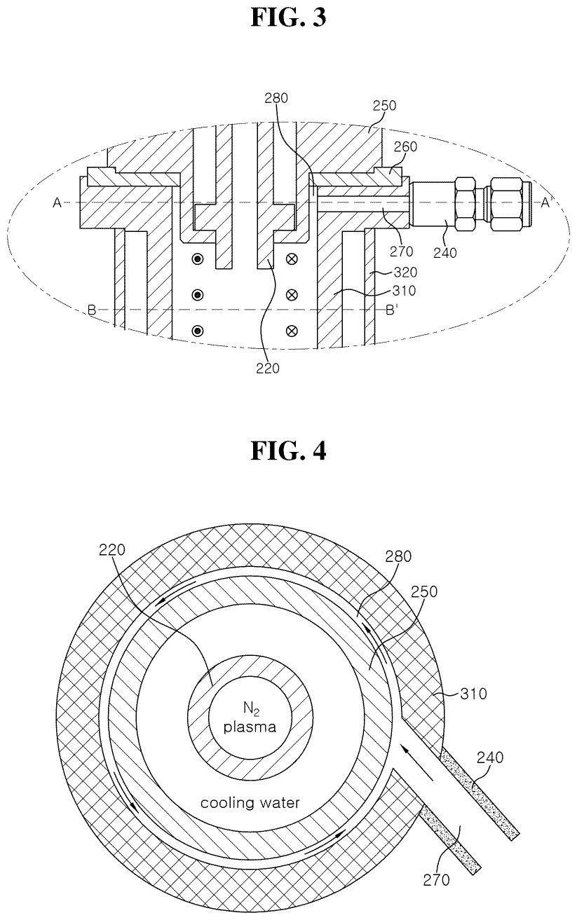

FIG. 3 is an enlarged cross-sectional view of the area where the second nitrogen inlet of FIG. 1 is connected, according to a preferred embodiment of the present inventive concept.

Referring to FIG. 3, a cooling member 250 is disposed on the side of the protruding portion of the pipe-shaped anode 220. The cooling member 250 is formed on the side of the anode 220, forming a space with the anode 220, and performs cooling of the nitrogen plasma formed within the anode 220 via cooling water filled in the space.

Furthermore, the nitrogen plasma is discharged through the internal space of the anode 220. A first inner wall 310 is disposed on the left and right sides of the cooling member 220. Specifically, the ends of the first inner wall 310 and the first outer wall 320 are horizontally extended, and a first gas path 270 into which nitrogen gas is introduced is formed therein. An insulating member 260 is interposed between the horizontally extended end portions of the first inner wall 310 and the first outer wall 320 and the cooling member 250. The insulating member 260 is preferably made of Teflon material and blocks the high voltage of the anode 220 from connecting to the first exhaust gas decomposition unit.

A second nitrogen inlet 240 is connected to the first gas path 270. Furthermore, a first flow space 280 is formed between the cooling member 250 and the first inner wall 310. The width of the first flow space 280 is set smaller than the width of the first gas path 270.

When nitrogen gas is introduced through the second nitrogen inlet 240, it flows through the first gas path 270. The nitrogen gas flowing through the first gas path 270 flows while rotating along the first flow space 280. The nitrogen gas flowing downward while rotating in a vortex pattern along the outer surface of the cooling member 250 maintains its rotational state within the gap space between the protruding portion of the anode 220 and the first inner wall 310. The nitrogen gas flows downward while rotating around the outer periphery of the first exhaust gas decomposition unit 300.

FIG. 4 is an upper cross-sectional view cut along line AA′ of FIG. 3 according to a preferred embodiment of the present inventive concept.

Referring to FIG. 4, a first gas path 270 is formed by penetrating an extended region of the first inner wall 310, and a second nitrogen inlet 240 is connected to the extended region of the first inner wall 310. The manner in which the second nitrogen inlet 240 is connected is such that it is disposed obliquely relative to the circular first inner wall 310. That is, it is not connected in a direction perpendicular to the circular first inner wall 310, but rather connected obliquely at a predetermined angle.

Nitrogen flowing through the first gas path 270 flows while rotating within the first flow space 280 defined by the first inner wall 310 and the cooling member 250.

Furthermore, the gap space between the cooling member 250 and the anode 220 is filled with cooling water to cool the nitrogen plasma flame generated within the internal space of the anode 220.

The nitrogen gas entering the peripheral region of the first exhaust gas decomposition unit takes on an expanded form due to the nitrogen gas rotating within the first flow space 280, caused by the protruding portion of the anode 220 directed toward the first exhaust gas decomposition unit.

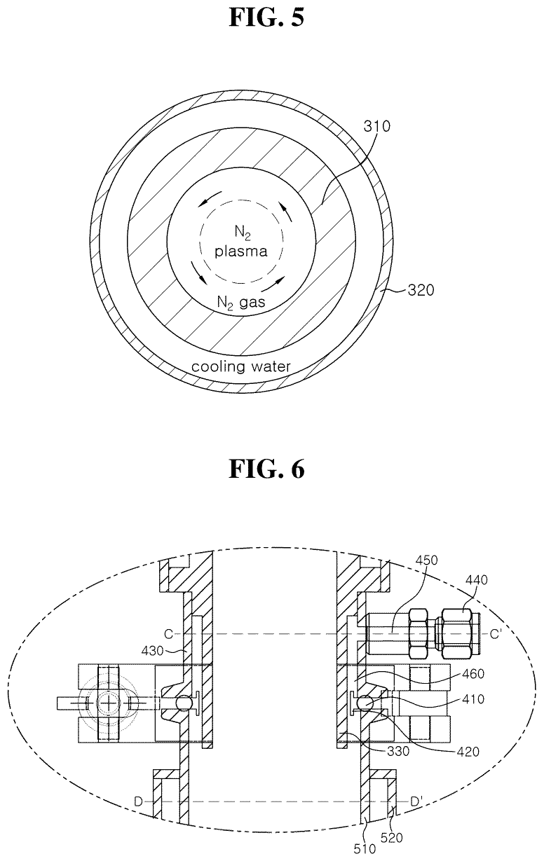

FIG. 5 is cross-sectional view cut along line BB′ of FIG. 3 according to a preferred embodiment of the present inventive concept.

Referring to FIG. 5, a first inner wall 310 and a first outer wall 320 are disclosed. First cooling water rotates and flows within the gap space between the first inner wall 310 and the first outer wall 320. Furthermore, nitrogen gas rotating within the first flow space, as described in FIG. 4, flows into the first exhaust gas decomposition unit and maintains its rotational state. Specifically, as it expands into the space between the lower protrusion of the anode and the first inner wall, as shown in FIG. 3, the nitrogen gas maintains its rotational state. Therefore, the plasma flame cannot expand into the region where the nitrogen gas rotates rapidly.

As described, the region where the plasma flame is defined is the central region, and the region where a curtain or barrier of nitrogen gas is formed by the rotation of the nitrogen gas is defined as the peripheral region. Exhaust gas entering the central region reacts with the nitrogen plasma and decomposes. The decomposed gases or particles are prevented from contacting the first inner wall 310 by the nitrogen gas rotating vigorously in the peripheral region. Consequently, reactive radicals or ionized particles cannot be adhered onto or react with the first inner wall 310 and are discharged from the first exhaust gas decomposition unit.

FIG. 6 is an enlarged cross-sectional view of the sealing unit of FIG. 1 according to a preferred embodiment of the present inventive concept.

Referring to FIG. 6, the extended upper portion of the second inner wall 510 is linked with the extended lower portion of the tapered inner wall 330. Since the outer diameter of the tapered inner wall 330 is smaller than the inner diameter of the second inner wall 510, the tapered inner wall 330 is fastened in a form where it is partially inserted into the second inner wall 510. Therefore, a second flow space 460 is formed between the tapered inner wall 330 and the second inner wall 510.

Furthermore, a third nitrogen inlet 440 is connected to one side of the sealing housing 430. Furthermore, an O-ring 410 is positioned as a sealing means between the sealing housing 430 and the second inner wall 510 to connect and seal the second inner wall 510 and the sealing housing 430. A centering ring 420 is connected to the O-ring 410 to prevent the O-ring 410 from dislodging. The O-ring 410 is positioned on the extended upper portion of the second inner wall 510, sealing the second flow space 460 from ambient air. Furthermore, the centering ring 420 has a size that does not block the second flow space 460, which is the gap between the tapered inner wall 330 and the second inner wall 510, or between the tapered inner wall 330 and the sealing housing 430.

An open hole is formed on one side surface of the sealing housing 430, and a third nitrogen inlet 440 is connected through the open hole. Nitrogen gas flowing through the third nitrogen inlet 440 into the second gas path 450 enters the second flow space 460 through the hole in the sealing housing 430. The nitrogen gas entering the second flow space 460 flows while rotating along the outer periphery of the tapered inner wall 330 and enters the second exhaust gas decomposition unit 500.

In particular, providing the sealing housing 430 separately in this embodiment is to secure design freedom. If the sealing housing 430 is not used, an O-ring is not required, and the second inner wall can be provided in an extended form, allowing the third nitrogen inlet to connect directly to the second inner wall through the hole formed in the upper portion of the second inner wall. In such a case, the second inner wall should be manufactured to be very long, causing significant obstacles in the manufacturing process during assembly and making it difficult to ensure the uniformity of the second flow space.

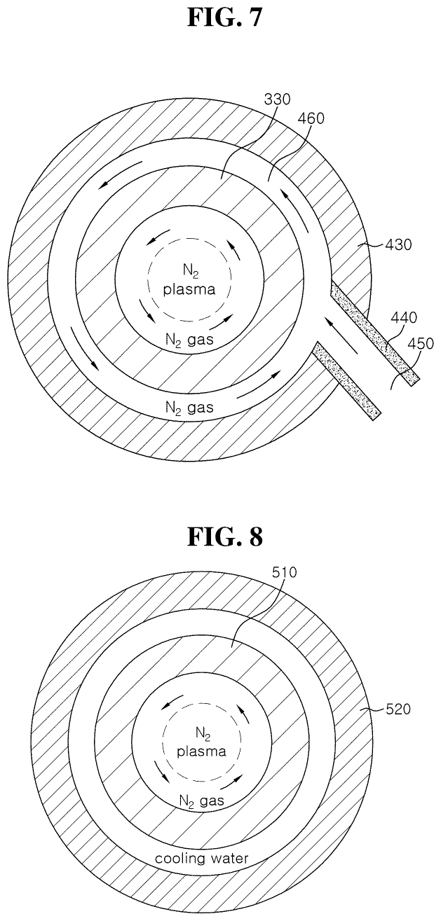

FIG. 7 is cross-sectional view cut along line CC′ of FIG. 6 according to a preferred embodiment of the present inventive concept.

Referring to FIG. 7, the central region of the tapered inner wall 330 is supplied with nitrogen plasma and is an extension of the first exhaust gas decomposition unit. Furthermore, the peripheral region within the tapered inner wall 330 is an area where nitrogen gas flows in a rotating manner, as described in FIG. 5.

A second flow space 460 is defined between the tapered inner wall 330 and the sealing housing 430. This second flow space 460 extends between the tapered inner wall 330 and the second inner wall, as shown in FIG. 6.

Nitrogen gas flowing in through the third nitrogen inlet 440 rotates and flows through the second flow space 460.

The nitrogen gas flow rotating within the peripheral region of the first exhaust gas decomposition unit in FIG. 7 weakens as it progresses downward. That is, it loses much of the kinetic energy from rotating within the peripheral region. Furthermore, the rotational direction of the nitrogen gas rotating within the second flow space 460 should be identical to the direction of the nitrogen gas rotating within the peripheral region of the first exhaust gas decomposition unit. If the directions of the two fluids are opposite, a curtain or barrier of nitrogen gas cannot be formed within the second exhaust gas decomposition unit.

FIG. 8 is cross-sectional view along line DD′ of FIG. 6 according to a preferred embodiment of the present inventive concept.

Referring to FIG. 8, cooling water flows through the gap space between the second inner wall 510 and the second outer wall 520. This enables the cooling operation of the second exhaust gas decomposition unit. Furthermore, the processing space within the second inner wall 510 is defined as a central region where nitrogen plasma is provided and a peripheral region where nitrogen gas flows in a rotating manner along the second inner wall 510. The nitrogen gas rotating in the outer region forms a curtain or barrier of non-reactive nitrogen gas, preventing the nitrogen plasma from contacting the second inner wall 510. It also prevents charged powders from adhering to the second inner wall 510 or radicals from depositing on the second inner wall 510.

The decomposition of exhaust gas through the aforementioned exhaust gas treatment apparatus can be described by the following reaction equations.

$${C}_{4} {F}_{10} + 4 {O}_{2} \to 4 C {O}_{2} + 5 {F}_{2} \qquad [ Reaction Equation 1 ]$$

$$C {F}_{4} + {O}_{2} \to C {O}_{2} + 2 {F}_{2} \qquad [ Reaction Equation 2 ]$$

$$S {F}_{6} + {O}_{2} \to S {O}_{2} + 3 {F}_{2} \qquad [ Reaction Equation 3 ]$$

$$Si {H}_{4} \to S {i}^{4 -} + 4 {H}^{+} \qquad [ Reaction Equation 4 ]$$

$${N}_{2} O \to 2 {N}^{3 +} + {O}^{6 -} \qquad [ Reaction Equation 5 ]$$

$$N {F}_{3} \to {N}^{3 +} + 3 {F}^{-} \qquad [ Reaction Equation 6 ]$$

$$W {F}_{6} \to {W}^{6 +} + 6 {F}^{-} \qquad [ Reaction Equation 7 ]$$

As described above, PFCs and other substances in the exhaust gas are decomposed and either resynthesized into other harmless compounds or ionized. The ionized PFCs are subsequently converted into N₂, CO₂, or H₂O in later processes and discharged.

### Experimental Example 1: N₂O Treatment Capacity

The N₂O treatment capacity of the exhaust gas treatment apparatus of the present inventive concept is tested. The amount of N₂ gas supplied from the vacuum pump is 100 slm (standard liters per minute), and the amount of N₂ gas supplied through the first nitrogen inlet is 12 slm. Furthermore, the amount of N₂O corresponding to the exhaust gas supplied through the exhaust gas inlet along with the N₂ gas is 10 slm.

The DC voltage applied between the anode and cathode to generate plasma is 188 V, and the discharge current is 37 A. To verify the N₂O treatment capacity of the exhaust gas treatment apparatus, the concentration of emitted N₂O is measured in the area where it is discharged from the second exhaust gas decomposition unit.

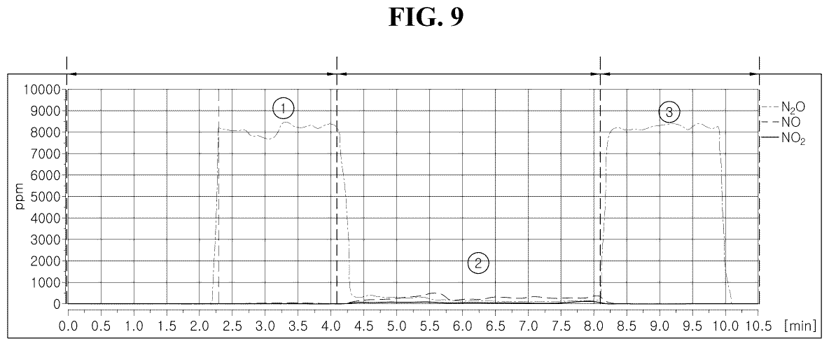

FIG. 9 is a graph for verifying the N₂O treatment capacity according to Experimental Example 1 of the present inventive concept.

Referring to FIG. 9, the N₂O concentration is measured at the terminal end of the second exhaust gas decomposition unit. Furthermore, the operation of turning the power supply of the plasma supply unit on and off is repeated, and the N₂O concentration is measured.

First, in section \textcircled{1}, when the power is off, nitrogen plasma is not generated. N₂O flows into the exhaust gas decomposition units and flows out as is. Therefore, the N₂O concentration has a value of 80,000 ppm or higher.

In section \textcircled{2}, when the nitrogen plasma is turned on, N₂O is decomposed by the nitrogen plasma. Consequently, the N₂O concentration in this section decreases sharply.

Again, in section \textcircled{3} where the plasma is turned off, N₂O is not decomposed due to the absence of plasma supply and is discharged at a high concentration.

### Experimental Example 2: Confirmation of NH₄Cl Treatment Capacity

The NH₄Cl treatment capacity of the exhaust gas treatment apparatus according to the present inventive concept is confirmed. The amount of N₂ gas supplied from the vacuum pump is 35 slm (standard liters per minute), and the amount of N₂ gas supplied through the first nitrogen inlet to the third nitrogen inlet is 5 slm. Furthermore, NH₄Cl corresponding to the exhaust gas is supplied together with the N₂ gas through the exhaust gas inlet.

The DC voltage applied between the anode and cathode to generate the plasma is 200 V, and the discharge current is 10 A.

The nitrogen plasma was turned off, and the nitrogen gas supplied to the second nitrogen inlet and third nitrogen inlet was shut off. As a result of turning off the plasma and shutting off the nitrogen gas, solid NH₄Cl is observed.

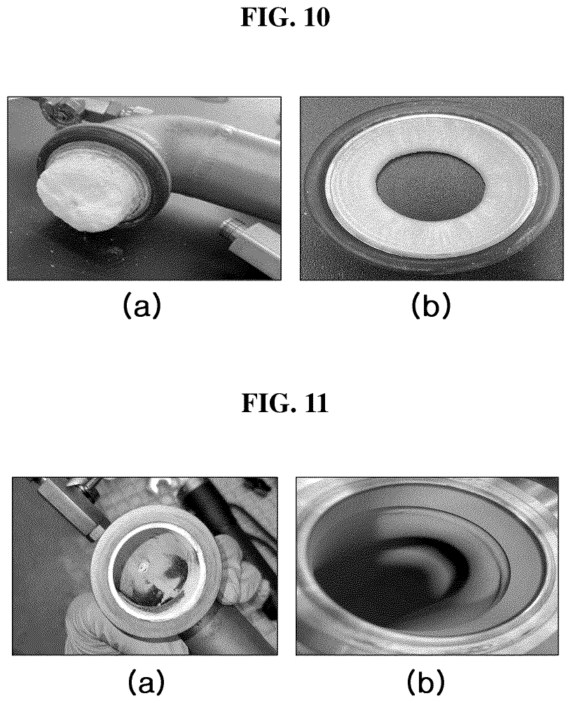

FIG. 10 is a cross-sectional image showing the case where the nitrogen gas supplied to the second nitrogen inlet and the third nitrogen inlet is cut off according to Experimental Example 2 of the present inventive concept.

Referring to FIG. 10, image (a) is an image between the first exhaust gas decomposition unit and the sealing unit. Furthermore, image (b) is a cross-sectional image of the second exhaust gas decomposition unit.

Referring to FIG. 10, it can be confirmed that white NH₄Cl deposits are formed on the first inner wall and second inner wall, and that the treatment space has been reduced due to the NH₄Cl deposition.

FIG. 11 shows cross-sectional views of the exhaust gas treatment apparatus of Experimental Example 2 of the present inventive concept when nitrogen plasma is activated and nitrogen gas is supplied through the second nitrogen inlet and third nitrogen inlet.

Referring to FIG. 11, it is confirmed in image (a) that no NH₄Cl deposition occurs in the space between the first exhaust gas decomposition unit and the sealing unit. Furthermore, it is confirmed in image (b) that no NH₄Cl deposition occurs on the second inner wall of the second exhaust gas decomposition unit, and the treatment space is maintained as is.

In the above-described inventive concept, the treatment space within the exhaust gas decomposition unit is defined as a central region and a peripheral region. Nitrogen plasma is generated through the central region, while inert nitrogen gas is supplied to the peripheral region by rotating along the inner wall. The concentration of nitrogen plasma increases due to the nitrogen gas rotating along the inner wall, thereby enhancing the treatment efficiency of the exhaust gas. Furthermore, the phenomenon where powder or reactive radicals introduced into the plasma deposit on the inner wall of the exhaust gas decomposition unit, blocking the inner wall space or contaminating the treatment space, is prevented.

Furthermore, to compensate for the limited processing capacity of the first exhaust gas decomposition unit, a second exhaust gas decomposition unit is connected. Nitrogen gas flows within the processing space of the second exhaust gas treatment unit, rotating in the outer region in the same direction as the first exhaust gas treatment unit. This protects the inner wall of the second exhaust gas treatment unit from deposition of powder and other substances.

1. An exhaust gas treatment apparatus comprising:
an exhaust gas inlet into which exhaust gas is introduced;
a plasma supply unit generating nitrogen plasma via arc discharge;
a first exhaust gas decomposition unit where the nitrogen plasma is supplied, and having a first central region and a first peripheral region outside the first central region in a first inner wall, wherein the exhaust gas is firstly treated by the nitrogen plasma in the first central region and a first nitrogen gas rotates in the first peripheral region;
a second exhaust gas decomposition unit connected to the first exhaust gas decomposition unit, having a second central region and a second peripheral region outside the second central region in a second inner wall, wherein the exhaust gas is secondary treated by the nitrogen plasma in the second central region and newly supplied second nitrogen gas rotates in the second peripheral region to confine the nitrogen plasma; and
a sealing unit that connecting the first exhaust gas decomposition unit and the second exhaust gas decomposition unit, and inducing rotational movement by the inflow of the second nitrogen gas.

2. The exhaust gas treatment apparatus of claim 1, wherein the plasma supply unit comprises, an anode and a cathode performing the arc discharge;
a first nitrogen inlet for supplying nitrogen gas as a source gas to generate the nitrogen plasma by the arc discharge;
a cooling member disposed on the side of the anode from which the nitrogen plasma is discharged and cooling the nitrogen plasma; and
a second nitrogen inlet connected to the cooling member and the first inner wall,
wherein a first flow space is formed between the cooling member and terminal portion of the first inner wall, and the first nitrogen gas introduced into the first flow space through the second nitrogen inlet performs rotational motion.

3. The exhaust gas treatment apparatus of claim 2, wherein the plasma supply unit further includes an insulating member for electrical insulation between the end portion of the first inner wall and the cooling member.

4. The exhaust gas treatment apparatus of claim 2, wherein the anode has a protruding portion relative to end portion of the cooling member, and the first nitrogen gas rotating in the first flow space is expanded by the protruding portion of the anode.

5. The exhaust gas treatment apparatus of claim 1, wherein the first exhaust gas decomposition unit further includes a first outer wall forming a gap space around the first inner wall, and cooling water rotates and flows within the space between the first inner wall and the first outer wall.

6. The exhaust gas treatment apparatus of claim 1, wherein the first exhaust gas decomposition unit further includes a tapered inner wall with a reduced thickness of the first inner wall in a region adjacent to the second exhaust gas decomposition unit, wherein the tapered inner wall is inserted into end portion of the second inner wall.

7. The exhaust gas treatment apparatus of claim 1, wherein the sealing unit comprises,
an O-ring formed at the upper end of the second inner wall;
a sealing housing disposed on the O-ring; and
a third nitrogen gas inlet connected to a hole at the sealing housing for supplying the second nitrogen gas.

8. The exhaust gas treatment apparatus of claim 7, wherein the sealing housing and the tapered inner wall forms a second flow space, and the second nitrogen gas flowing into the second performs rotational motion within the second flow space.

9. The exhaust gas treatment apparatus of claim 8, wherein the second nitrogen gas rotating in the second flow space is introduced into the second peripheral region within the second exhaust gas decomposition unit.

10. The exhaust gas treatment apparatus of claim 1, wherein rotational direction of the first nitrogen gas rotating in the first peripheral region is the same as rotational direction of the second nitrogen gas rotating in the second peripheral region.

11. The exhaust gas treatment apparatus of claim 1, wherein temperature of the nitrogen plasma in the first central region is higher than temperature of the nitrogen plasma in the second central region.

12. The exhaust gas treatment apparatus of claim 1, wherein the nitrogen gases circulating within the first peripheral region and the second peripheral region prevent powder within the exhaust gas from depositing onto the first inner wall or the second inner wall.

13. An exhaust gas treatment apparatus comprising:
an exhaust gas inlet in which exhaust gas is introduced;
a plasma supply unit for forming a nitrogen plasma to decompose the exhaust gas, into which a first nitrogen gas is introduced to induce rotational motion;
a first exhaust gas decomposition unit connected to the plasma supply unit, into which the exhaust gas is introduced for decomposition, in which the nitrogen plasma is confined by the rotational motion of the first nitrogen gas and the exhaust gas is firstly decomposed by the nitrogen plasma;
a second exhaust gas decomposition unit connected to the first exhaust gas decomposition unit, in which the exhaust gas is secondary decomposed and the nitrogen plasma is confined by the rotation of second nitrogen gas; and
a sealing unit for connecting the first exhaust gas decomposition unit and the second exhaust gas decomposition unit, and for supplying the second nitrogen gas.

14. The exhaust gas treatment apparatus of claim 13, wherein the plasma supply unit comprises,
a cathode and an anode for generating the nitrogen plasma;
a first nitrogen inlet for supplying nitrogen gas to the nitrogen plasma;
a cooling member disposed on the side of the anode supplying the nitrogen plasma to the first exhaust gas decomposition unit; and
a second nitrogen inlet supplying the first nitrogen gas through a first flow space formed between the cooling member and upper portion of the first exhaust gas decomposition unit.

15. The exhaust gas treatment apparatus of claim 14, wherein the second nitrogen inlet is connected obliquely to the upper end portion of the circular first exhaust gas decomposition unit and induces rotation of the first nitrogen gas in the first flow space.

16. The exhaust gas treatment apparatus of claim 13, wherein the sealing unit comprises,
an O-ring disposed at upper end of the second exhaust gas decomposition unit;
a sealing housing formed on the O-ring, which forms a second flow space with tapered inner wall of the first exhaust gas decomposition unit; and
a third nitrogen inlet connected to a hole of the sealing housing, through which the second nitrogen gas is introduced,
wherein the second nitrogen gas rotating in the second flow space is introduced into the second exhaust gas decomposition unit, thereby rotating within the second exhaust gas decomposition unit.

17. The exhaust gas treatment apparatus of claim 16, wherein the third nitrogen inlet is connected obliquely to the surface of the circular sealing housing.
